(19) United States
(12) Patent Application Publication
(10) Pub. No.: US 2022/0415331 A1
(43) Pub. Date: Dec. 29, 2022

(54) METHODS AND APPARATUS FOR PANELIST-BASED LOGINS USING VOICE COMMANDS

(71) Applicant: The Nielsen Company (US), LLC, New York, NY (US)

(72) Inventors: Alexander Topchy, New Port Richey, FL (US); Timothy Scott Cooper, Tarpon Springs, FL (US); Jeremey M. Davis, New Port Richey, FL (US)

(21) Appl. No.: 17/356,465

(22) Filed: Jun. 23, 2021

(51) Int. Cl. G10L 17/22; G10L 19/018

(52) U.S. Cl. CPC G10L 17/22; G10L 19/018

(57) ABSTRACT

Methods and apparatus for panelist-based logins using voice commands are disclosed herein. A disclosed example apparatus for identifying a user as a member of an audience includes a memory and at least one processor to execute machine readable instructions to at least access audio emitted by a speech recognition system, the audio generated based on a request spoken by the user, identify at least one of a watermark or a fingerprint included in the audio, the watermark or fingerprint including identifying information to identify a user and an indication of the presence of the user, and record the indication of the presence of the user in an audience.

### FIELD OF THE DISCLOSURE

The present disclosure relates generally to monitoring media and, more particularly, to methods and apparatus for panelist-based logins using voice commands.

### BACKGROUND

Media content is accessible to users through a variety of platforms. For example, media content can be viewed on television sets, via the Internet, on mobile devices, in-home or out-of-home, live or time-shifted, etc. Understanding consumer-based engagement with media within and across a variety of platforms (e.g., television, online, mobile, and emerging) allows content providers and website developers to increase user engagement with their media content.

### BRIEF DESCRIPTION OF THE DRAWINGS

FIG. 1 is a block diagram illustrating an example operating environment, constructed in accordance with teachings of this disclosure, in which a meter of an audience measurement entity (AME) receives, via a speech recognition system, an audio signal associated with an example user request.

FIG. 2 is a block diagram of an example implementation of the speech recognition system of FIG. 1.

FIG. 3 is a block diagram of an example implementation of the audience measurement entity (AME) meter of FIG. 1.

FIG. 4 is a flowchart representative of machine readable instructions which may be executed to implement elements of the example speech recognition system of FIGS. 1 and/or 2.

FIG. 5 is a flowchart representative of machine readable instructions which may be executed to implement elements of the example AME meter(s) of FIGS. 1 and/or 3.

FIG. 6 is a block diagram of an example processing platform structured to execute the instructions of FIG. 3 to implement the example speech recognition system of FIGS. 1 and/or 2.

FIG. 7 is a block diagram of an example processing platform structured to execute the instructions of FIG. 4 to implement the example AME meter(s) of FIGS. 1 and/or 3.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Audience measurement entities (also referred to herein as “ratings entities”) determine demographic reach for advertising and media programming based on registered panel members. That is, an audience measurement entity enrolls people who consent to being monitored into a panel. During enrollment, the audience measurement entity receives demographic information from the enrolling people so that subsequent correlations may be made between advertisement/media exposure to those panelists and different demographic markets. Audience measurement techniques can be used to help broadcasters and/or advertisers determine information about their viewership and/or listenership based on media watermarking. For example, a portable metering device can be used to capture audio emanating from a media device (e.g., a radio, a television, etc.) in a user's home or other location, such as an automobile. Panelists are users who have provided demographic information at the time of registration into a panel, allowing their demographic information to be linked to the media they choose to listen to or view.

As a result, panelists represent a statistically significant sample of the large population of media consumers, for example, which allow broadcasting companies and advertisers to better understand who is utilizing their media content and maximize revenue potential. For example, audience measurement entities (AMEs) such as The Nielsen Company (US), LLC may provide a portable people meter (PPMs) and/or stationary metering devices (e.g., such as Global Television Audience Metering (GTAM) meters, A/P meters, Nano meters, etc.) to their panelists. The metering device(s) can perform signal processing of the audio conveyed to a broadcast (e.g., a radio broadcast) to extract the watermark symbols. An example watermark that is widely used is the Critical Band Encoding Technology (CBET) watermark invented by Jensen, et al. See U.S. Pat. Nos. 5,450,490 and 5,764,763, which are incorporated herein by reference. CBET watermarking consists of a data packet with 32 bits: 16 bits used for purposes of station identification and 16 bits used for a timestamp. For example, once a PPM has retrieved the watermark, the PPM can transmit the complete or partial watermark back to an AME. Besides watermarking using CBET, there are other encoding systems that insert an identifier into audio media. For example, the Nielsen Audio Encode System II (also known as NAES2) can insert a Nielsen source identifier and timestamp into, for example, an audio signal. Examples of watermarking techniques for encoding watermarks into media signals, such as audio signals, which can be supported by the teachings of this disclosure are described in U.S. Pat. No. 8,359,205, entitled “Methods and Apparatus to Perform Audio Watermarking and Watermark Detection and Extraction,” which issued on Jan. 22, 2013, U.S. Pat. No. 8,369,972, entitled “Methods and Apparatus to Perform Audio Watermarking Detection and Extraction,” which issued on Feb. 5, 2013, U.S. Publication No. 2010/0223062, entitled “Methods and Apparatus to Perform Audio Watermarking and Watermark Detection and Extraction,” which was published on Sep. 2, 2010, U.S. Pat. No. 6,871,180, entitled “Decoding of Information in Audio Signals,” which issued on Mar. 22, 2005, U.S. Pat. No. 5,764,763, entitled “Apparatus and Methods for Including Codes in Audio Signals and Decoding,” which issued on Jun. 9, 1998, U.S. Pat. No. 5,574,962, entitled “Method and Apparatus for Automatically Identifying a Program Including a Sound Signal,” which issued on Nov. 12, 1996, U.S. Pat. No. 5,581,800, entitled “Method and Apparatus for Automatically Identifying a Program Including a Sound Signal,” which issued on Dec. 3, 1996, U.S. Pat. No. 5,787,334, entitled “Method and Apparatus for Automatically Identifying a Program Including a Sound Signal,” which issued on Jul. 28, 1998, and U.S. Pat. No. 5,450,490, entitled “Apparatus and Methods for Including Codes in Audio Signals and Decoding,” which issued on Sep. 12, 1995, all of which are hereby incorporated by reference in their respective entireties.

An example CBET watermark is constructed using symbols representing 4 bits of data. Each of the symbols is encoded in 400 milliseconds of the media audio component and is created by embedding a particular set of 10 tones representing each symbol, with different sets of tones being used to represent different symbol values. Each of the tones belongs to a band of code consisting of several closely-spaced frequencies of the audio (e.g., 1-3 kHz frequency range for CBET watermarking). The 400 millisecond symbol block boundaries are typically not known to the meter decoding process, and a scan capturing a 256 millisecond window across an audio stream is performed. Watermarks embedded into media broadcasts should be properly encoded to ensure that the watermarks can be reliably detected in various listening environments. While watermarking introduces additional information into the audio signal (e.g., watermark embedding within the signal), fingerprinting is another method of identifying an audio signal without adding any additional information into the signal, such that the signal remains unmodified. For example, fingerprints can be stored in a database and any audio signal received can be compared with fingerprints on file to determine if there is a match (e.g., based on audio signal waveform, etc.). As such, fingerprinting analyzes a given audio signal to determine the unique characteristics associated with the audio content, such that an identified pattern can be stored in a database and used for recognizing the same content in the future.

While metering device(s) (e.g., PPMs, Nano meters, etc.) can perform signal processing of audio conveyed to a broadcast (e.g., a radio broadcast) to extract the watermark symbols to identify media content being viewed and/or listened to by a panelist, current methods of identifying a panelist's presence in a viewing area within the panelist's home includes the use of a dedicated remote control (e.g., AME-provided remote control). For example, pressing a dedicated button on the remote control causes the AME meter(s) to register if a given user (e.g., the panelist) has started or stopped watching television. Given the need for the user to interact with the remote control to log data, such a procedure introduces compliance issues and can lower the quality of the collected audience data. Introducing acoustic-based methods of sending a user request and/or command via a speech recognition system to the AME meter(s) (e.g., PPMs, Nano meters, etc.) would permit replacement of standard radio frequency (RF) channels with data-over-sound for improved audience measurements.

Methods and apparatus disclosed herein permit panelist-based logins using voice commands. In the examples disclosed herein, AME meter(s) can be used to receive user-based requests initiated via a speech recognition system (e.g., Amazon Alexa, Google Home, Apple Homepod, etc.). For example, AME meter(s) include a microphone to extract audio fingerprints and/or audio watermarks used for content recognition. In the examples disclosed herein, the AME meter(s) can receive commands from a user (e.g., an AME panelist) via the speech recognition system. For example, given that AME meter(s) can be constrained in terms of computational resources, running speech recognition and/or speaker recognition tasks in real-time on the meter itself would consume additional compute time. As such, speech recognition can be delegated to a smart device (e.g., the speech recognition system) present in a panelist home.

In some examples, the smart device can be programmed to respond to login requests by playing a sound which can be detected by the AME meter(s). For example, a designated room of a panelist household can include the speech recognition system to receive panelist-based requests and/or commands (e.g., a household with Alexa smart speakers and/or Nano meters located in a room of the household). In the examples disclosed herein, an individual (e.g., a panelist) entering the room joins a particular viewing (e.g., watching a television segment, listening to an advertisement, etc.). In the examples disclosed herein, the panelist (e.g., Bob) can initiate a request to the AME meter(s) via the speech recognition system (e.g., “Alexa, login Bob to Nano”, “Alexa, log me in to the AME meter”). In the examples disclosed herein, the speech recognition system (e.g., Amazon Alexa) executes an associated task (e.g., acoustically playing an audio signal unique to the panelist's login). In the examples disclosed herein, the AME meter can receive the sound burst (e.g., audio signal), given that the AME meter is searching for watermarks and/or fingerprints in real-time. In some examples, the AME meter can identify the signal as one associated with the panelist's login, allowing the panelist to be included in the audience. In the examples disclosed herein, the panelist can similarly initiate a logout request when exiting the room (e.g., “Alexa, logout Bob from Nano”, “Alexa, log me out of the AME meter”). As such, the speech recognition system can once again recognize the log-out request and acoustically play an audio signal unique to the panelist's logout. In some examples, the AME meter(s) can receive the “logout Bob” sound, thereby removing the panelist from the audience list.

In the examples disclosed herein, the sound or audio burst can be any acceptable audio signal capable of communicating information, such as the login/logout instruction and/or an identifier of the user the AME meter(s). In some examples, the speech recognition system can be logged into a user account of the AME that identifies the names and/or identifiers of a given person, allowing the speech recognition system to generate an audio output based on the identification. In some examples, the AME meter can determine the individual being referred to based on lexical matching, a lookup of panelist identifier(s) based on the provided name, etc. In some examples, any unrecognized individuals can be logged in by the AME meter as guest(s) if the AME meter does not recognize the individual by name and/or unique identifier. In some examples, the AME meter(s) can receive a watermark with or without any acoustic masking. Alternatively, the audio signal can include a unique audio fingerprint recognized by the AME meter(s). For example, the AME meter(s) can generate a stream of fingerprints from the AME meter-based microphone. If the AME meter recognizes fingerprints including a pre-determined “login Bob” sequence, the AME meter can register Bob as part of the audience in a given location (e.g., a designated room in the panelist household) and/or at a given time interval (e.g., the duration of the panelist's presence in the room). As such, audience measurement can be improved with increased convenience for the user, given that the user (e.g., the panelist) can vocally express their intention of being added to the audience list without having to physically interact with a designated remote control to log data associated with the panelist.

While in the examples disclosed herein the panelist is logged in and/or logged out based on a request processed by the AME meter(s) via the speech recognition system, the panelist can issue any other type of command(s) through the speech recognition system (e.g., smart speaker). For example, the panelist can indicate presence of guests and/or initiate a help request. For example, the necessary commands can be pre-programmed and/or the audio signal(s) to be played as a reaction to the given command(s), allowing the AME meter(s) to recognize the command(s) based on, for example, a watermark included with the audio signal. In some examples, the AME meter(s) can be configured to detect and/or recognize a specific pattern of a fingerprint and/or watermark payload corresponding to the given command(s). In some examples, the speech recognition system can automatically recognize a speaker (e.g., the panelist) based on a voice or a designated word and transmit an audio signal to the AME meter(s) indicating the identity of the speaker and/or the speaker's command. In turn, the AME meter(s) can log data received from the speech recognition system(s) with the audience measurement entity (AME).

As used herein, the term “media” refers to content and/or advertisements. As used herein, the terms “code” and “watermark” are used interchangeably and are defined to mean any identification information (e.g., an identifier) that may be inserted or embedded in the audio signal for the purpose of identifying a user or for another purpose (e.g., identifying a user request, etc.). In some examples, to identify watermarked media, the watermark(s) are extracted and, for example, decoded and/or used to access a table of reference watermarks that are mapped to media identifying information.

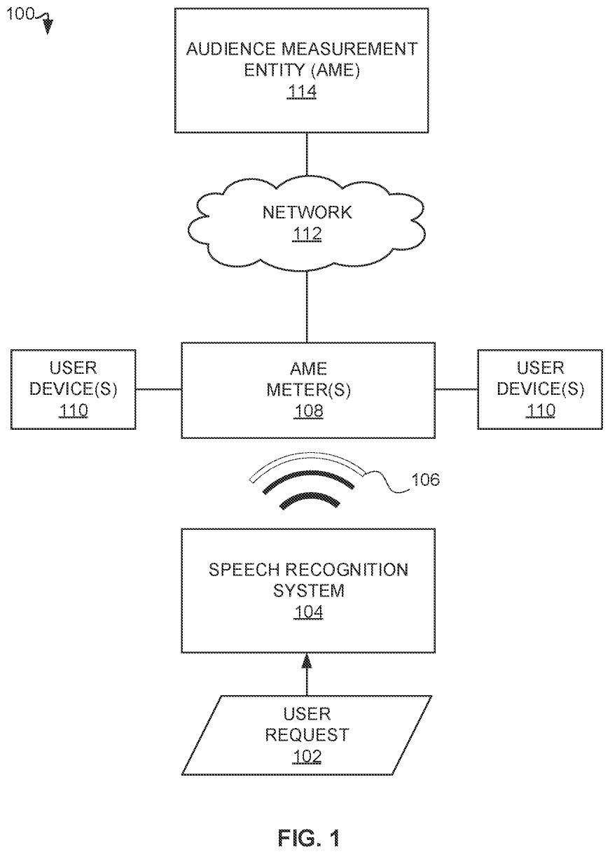

FIG. 1 is a block diagram illustrating an example operating environment 100, constructed in accordance with teachings of this disclosure, in which a meter of an audience measurement entity (AME) receives, via a speech recognition system, an audio signal associated with an example user request. The operating environment 100 includes an example user request 102, an example speech recognition system 104, an example network signal 106, example AME meter(s) 108, example user device(s) 110, an example network 112, and an example audience measurement entity (AME) 114.

The user request 102 includes any user request generated by a panelist. For example, the user request 102 can include a log-in request or a log-out request when a panelist enters or leaves a room, respectively, in a household where AME-based monitoring is performed (e.g., a household including AME meter(s)). In some examples, the user request 102 can include an oral request that is received by the speech recognition system 104. In some examples, the oral request can indicate that the request is intended for the speech recognition system 104 by directing the speech recognition system 104 to perform a task (e.g., “Alexa, login Bob to Nano”). In some examples, the user request 102 can include other information, such as the number of guests present and/or the names of any other household members present in the room with the panelist. In some examples, the user request 102 can include any other type of request and/or command initiated by a user.

The speech recognition system 104 can be any system that can recognize the user request 102. In some examples, the speech recognition system 104 can be any type of device that can be used as a voice service (e.g., cloud-based voice service that processes and/or retains audio, interactions, and/or other data). For example, the speech recognition system 104 can include and/or may be implemented using smart devices such as Amazon Alexa, Google Home, Apple Homepod, etc. In some examples, the speech recognition system 104 can be programmed to respond to login requests by playing a sound which can be detected by the AME meter(s) 108. For example, a designated room of a panelist household can include the speech recognition system 104 to receive panelist-based requests and/or commands (e.g., a household with Alexa smart speakers located in a room of the household). In some examples, the speech recognition system 104 identifies the user request 102 based on a wake word used as part of the user request 102 (e.g., “Alexa”, “Amazon”, “Echo”, “Computer”, etc.). For example, the speech recognition system 104 can identify the rest of the user request 102 once the wake word is pronounced by the user (e.g., the panelist) using keyword spotting (e.g., based on acoustic patterns of the wake word). In some examples, the speech recognition system 104 can be trained to recognize any other kind of wake word and/or indication of the user request. In some examples, the speech recognition system 104 indicates to the user that the user request 102 is being processed (e.g., using a light indicator). In some examples, the speech recognition system 104 transmits the user request 102 to the AME meter(s) 108 using the network signal 106 (e.g., using a watermark and/or fingerprint as the user identifying information when relating the user request 102 to the AME meter(s) 108). In some examples, the speech recognition system 104 includes a microphone to identify a vocal user request 102.

The network signal 106 can be any signal used by the speech recognition system 104 to send the user request 102 to the AME meter(s) 108. In some examples, the network signal 106 is a wireless signal. In some examples, the network signal 106 includes an audio signal used to identify the user request 102 to the AME meter(s) 108. For example, the network signal 106 can include a watermark and/or a fingerprint to allow the AME meter(s) 108 to identify the user request 102 as a request to log-in a user or log-out a user (e.g., include a panelist in the audience count maintained by the AME 114). In some examples, the speech recognition system 104 can use the network signal 106 to transmit the user request 102 to the AME meter(s) 108 based on a watermark with or without any acoustic masking.

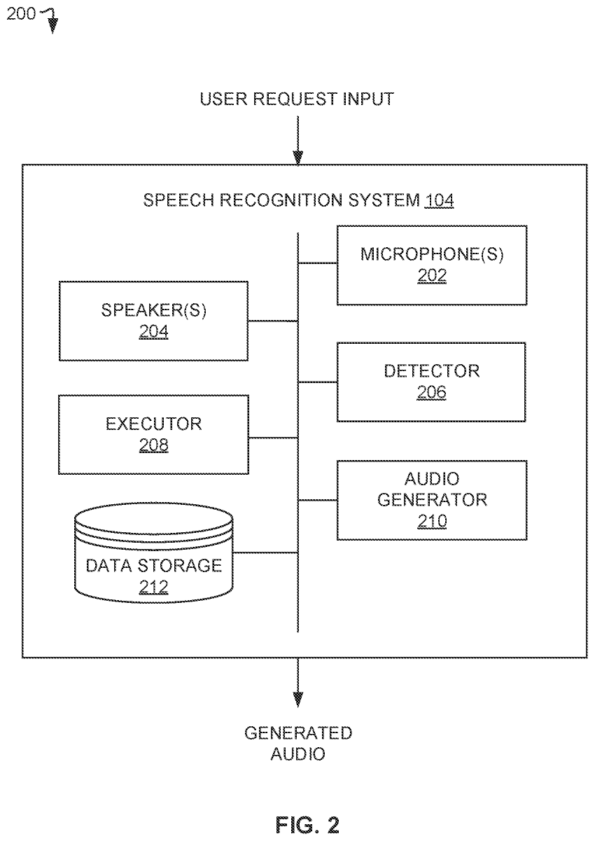

The AME meter(s) 108 receive the user request 102 transmitted by the speech recognition system 104. In some examples, the AME meter(s) 108 can be any type of AME meter that can extract a watermark and/or a fingerprint from the network signal 106. In some examples, the AME meter(s) can include a portable people meter (PPMs) and/or a stationary metering device (e.g., such as Global Television Audience Metering (GTAM) meters, A/P meters, Nano meters, etc.) provided to AME panelists. In some examples, the AME meter(s) 108 process the network signal 106 using an audio signal receiver, an evaluator, a data logger, and/or a data storage, as described in connection with FIG. 2. In some examples, the AME meter(s) 108 can also include a memory, a microphone, a wireless transceiver, and/or a power supply (e.g., rechargeable batteries). The AME meter(s) 108 can identify a watermark and/or a fingerprint in the network signal 106 received from the speech recognition system 104. For example, the AME meter(s) 108 can identify and/or timestamp signature(s) and/or code(s) in the audio signals (e.g., network signal 106) received from the speech recognition system 104. Once the AME meter(s) 108 retrieve a watermark and/or a fingerprint from the network signal 106, the AME meter(s) 108 identify whether a panelist and/or other member(s) of the household should be included in an audience count (e.g., logged in) or removed from the audience count (e.g., logged out). In some examples, the AME meter(s) 108 determine what user device(s) 110 are in the room of the panelist household and associate the panelist as an audience member for a certain user device 110 (e.g., a television show, an advertisement, a webpage, etc.).

The user device(s) 110 can be stationary or portable computers, handheld computing devices, smart phones, Internet appliances, and/or any other type of device that may be connected to a network (e.g., the Internet) and capable of presenting media. In the illustrated example of FIG. 1, the user device(s) 110 can include a smartphone (e.g., an Apple® iPhone®, a Motorola™ Moto X™, a Nexus 5, an Android™ platform device, etc.), a laptop computer, a tablet (e.g., an Apple® iPad™, a Motorola™ Xoom™, etc.), a desktop computer, a camera, an Internet compatible television, a smart TV, etc. The user device(s) 110 of FIG. 1 are used to access (e.g., request, receive, render and/or present) online media provided, for example, by a web server. The user device(s) 110 can be used to present streaming media (e.g., via an HTTP request) from a media hosting server. The web server can be any web browser used to provide media content (e.g., YouTube) that is accessed, through the example network 112 on the user device(s) 110.

The network 112 may be implemented using any suitable wired and/or wireless network(s) including, for example, one or more data buses, one or more Local Area Networks (LANs), one or more wireless LANs, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events.

The AME 114 operates as an independent party to measure and/or verify audience measurement information relating to media accessed by subscribers of a database proprietor. When media is accessed using the user device(s) 110, the AME 114 stores information relating to user viewership and/or media exposure (e.g., length of time that a panelist viewed a television program, etc.). In some examples, the AME 114 receives demographic information from the enrolling people (e.g., panelists) so that subsequent correlations may be made between advertisement/media exposure to those panelists and different demographic markets, allowing the panelists to represent a statistically significant sample of the large population of media consumers.

FIG. 2 is a block diagram 200 of an example implementation of the speech recognition system 104 of FIG. 1. In the example of FIG. 2, the speech recognition system 104 includes example microphone(s) 202, example speaker(s) 204, an example detector 206, an example executor 208, an example audio generator 210, and an example data storage 212. audio receiver 310 evaluator 312 people identifier 314 data storage 318

The microphone(s) 202 can be used to serve as an input to the detector 206 and/or the executor 208 (e.g., input corresponding to the user request 102 of FIG. 1 and/or any other type of audio-based signal). The microphone(s) 202 of the speech recognition system 104 can be positioned to obtain a clear input signal from any portion of the room in which the speech recognition system 104 is present.

The speaker(s) 204 can serve as an output to the executor 208 and/or the audio generator 210. For example, the speaker(s) 204 can be used by the executor 208 and/or the audio generator 210 to provide information to the user (e.g., answer a question posed by the user, etc.).

The detector 206 identifies the user request 102 of FIG. 1. For example, the detector 206 identifies the user request 102 based on a wake word (e.g., a word used by the user at the beginning of the verbal request to alert the speech recognition system 104). In some examples, the detector 206 identifies the user request 102 based on key words used in the request 102. For example, the user (e.g., the panelist) can request that the speech recognition system 104 log-in and/or log-out the user and/or other members of the household. However, any other method of identifying the user request 102 can be used. For example, the detector 206 can identify the user's presence based on the user's voice and/or the voice of other member(s) of the panelist household. In some examples, the detector 206 identifies the user request 102 based on acoustic patterns (e.g., using keyword spotting).

The executor 208 executes the user request 102 once the detector 206 has identified the user request 102. For example, the executor 208 identifies the content and/or category of the user request 102 (e.g., log-in request, request for assistance, etc.). In some examples, the executor 208 determines the category of the user request 102 based on the keywords identified by the detector 206. In some examples, the executor 208 determines the type of audio signal (e.g., watermarking and/or fingerprinting) to include with the network signal 106 used to transmit the user request 102 to the AME meter 108. In some examples, the executor 208 determines whether to transmit the watermark to the AME meter 108 with or without any acoustic masking. In some examples, the executor 208 identifies the watermark and/or fingerprint to include with an audio signal (e.g., the network signal 106) based on the user identity and/or user request (e.g., log-in request, log-out request, request to log-in additional members of the household, etc.). In some examples, the executor 208 identifies any additional information in the user request 102 to provide to the AME meter 108. In some examples, the additional information can include information about additional member(s) of the household and/or visitors in a designated room of the household that includes the user device(s) 110. For example, if the room where the speech recognition system 104 and/or the AME meter 108 includes a television that is turned on, the additional information provided by the user request 102 can include the demographics of the individual(s) joining the user in the room (e.g., thereby also joining as audience members for a given media content provided by the television).

The audio generator 210 generates an audio signal used to convey the user request 102 to the AME meter 108 via the network signal 106. In some examples, the audio generator 210 includes a unique audio signal (e.g., corresponding to the user request 102) that can be recognized by the AME meter 108. For example, the audio generator 210 can be used by the speech recognition system 104 to emit an audio signal that is unique to a given panelist. For example, the audio generator 210 generates an audio signal unique to Bob when Bob enters the designated room of the household and provides the user request 102 (e.g., “Alexa, login Bob”). The audio generator 210 can be programmed to generate audio signals that are specific to a database of watermarks and/or fingerprints accessible to the AME meter 108. For example, the audio generator 210 can generate a watermark with or without acoustic marking. In some examples, the audio generator 210 can generate a unique audio fingerprint that is identifiable only to the AME meter 108.

The data storage 212 stores any data associated with the detector 206, the executor 208, and/or the audio generator 210. For example, the data storage 212 can store information related to the user request 102, such as the type of request (e.g., log-in request, log-out request). The data storage 212 can be a cloud-based storage (e.g., storage on the network 112). In some examples, the data storage 212 may be implemented by any storage device and/or storage disc for storing data such as, for example, flash memory, magnetic media, optical media, etc. Furthermore, the data stored in the data storage 212 may be in any data format such as, for example, binary data, comma delimited data, tab delimited data, structured query language (SQL) structures, etc. While in the illustrated example the data storage 212 is illustrated as a single database, the data storage 212 can be implemented by any number and/or type(s) of databases.

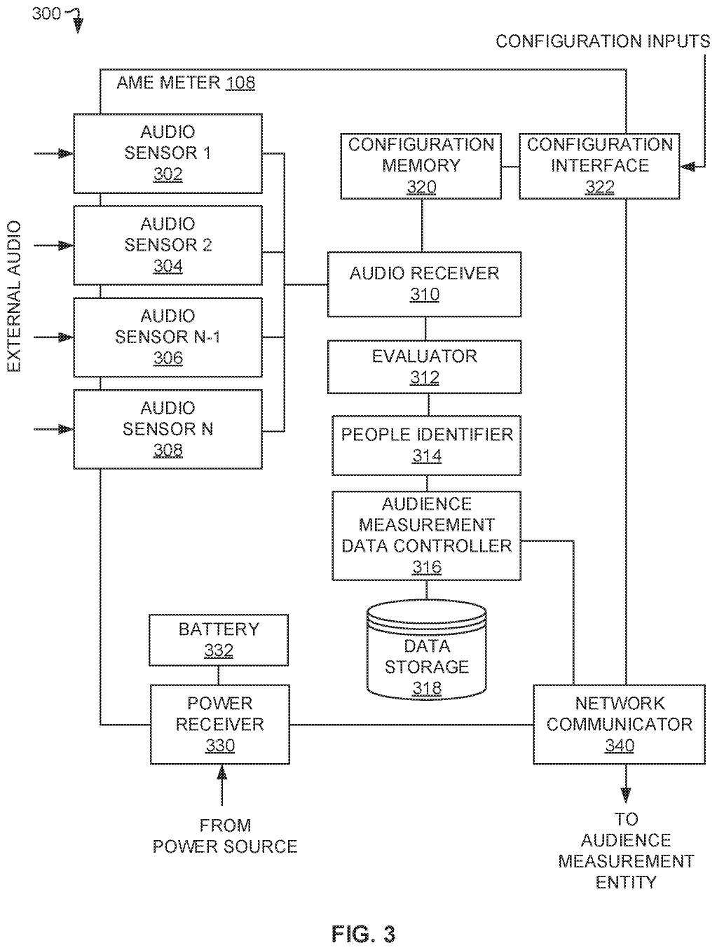

FIG. 3 is a block diagram of an example implementation of the audience measurement entity (AME) meter 108 of FIG. 1. The AME meter 108 includes example audio sensor(s) 302, 304, 306, 308, an example audio receiver 310, an example evaluator 312, an example people identifier 314, an example audience measurement data controller 316, and an example data storage 318. The AME meter 108 also includes an example configuration memory 320, an example configuration interface 322, an example power receiver 330, an example battery 332, and an example network communicator 340.

The audio sensor(s) 302, 304, 306, 308 can be used to monitor for audio output from the speech recognition system 104 of FIG. 2 (e.g., external audio). In some examples, the audio sensor(s) 302, 304, 306, 308 can be used to monitor the vicinity (e.g., of the media presentation environment) for external audio originating from the speech recognition system 104 to facilitate identification of the panelist and/or guest entering and/or leaving the media presentation environment. The audio sensor(s) 302, 304, 306, 308 can be implemented by microphone(s) and/or any other type of acoustic sensor(s). The audio sensor(s) 302, 304, 306, 308 can be positioned to receive audio with sufficient quality to identify the external audio generated by the speech recognition system 104 of FIG. 2. While four audio sensor(s) 302, 304, 306, 308 are shown in the example of FIG. 3, any number of audio sensors may additionally or alternatively be used.

The audio receiver 310 receives audio generated by the audio generator 210 of the speech recognition system 104 from the audio sensor(s) 302, 304, 306, 308. In some examples, the audio receiver 310 receives a watermark and/or fingerprint as part of the network signal 106 transmitted by the speech recognition system 104. In some examples, the audio receiver 310 identifies a specific pattern of the fingerprint and/or watermark payload received from the speech recognition system 104. Furthermore, the audio receiver 310 can be used to receive an audio signal that is unique to a given panelist and/or a given user request 102. In some examples, the audio receiver 310 receives an audio signal that is specific to a database of watermarks and/or fingerprints accessible to the AME meter 108. In some examples, the audio receiver 310 identifies a watermark with or without acoustic marking. In some examples, the audio receiver 310 identifies a unique audio fingerprint generated by the audio generator 210.

The evaluator 312 evaluates the data received by the audio receiver 310. In some examples, the evaluator 312 compares identified watermark(s) and/or fingerprint(s) against a database accessible to the AME meter 108 (e.g., data storage 318). For example, the user request 102 can be identified by the evaluator 312 based on a specific fingerprint and/or watermark pattern. In some examples, the fingerprint and/or watermark pattern can correspond to commands that have been configured to the AME meter 108 for detection. For example, a fingerprint and/or watermark pattern can correspond to a log-in request or a log-out request initiated by the user request 102. In some examples, the fingerprint and/or watermark pattern can identify a specific panelist initiating the user request 102. In some examples, the evaluator 312 can identify any other type of request (e.g., request to add additional household members to the audience, request for helps, etc.), depending on how the AME meter 108 are programmed to receive and/or interpret a given fingerprint and/or watermark pattern.

The people identifier 314 logs any data received by the AME meter 108 in connection with the audio signal received by the audio receiver 310 to identify an audience member as a panelist and/or a guest. In some examples, the people identifier 314 can be used to keep track of users (e.g., panelists) who enter and/or exit a given room of the household to include the panelist(s) as audience members when user device(s) 110 (e.g., a television) are turned on and/or presenting media. In some examples, the people identifier 314 logs the fingerprint and/or watermark pattern(s) received by the audio receiver 310 and/or identified by the evaluator 312. In some examples, the people identifier 314 adds the user (e.g., the panelist) to an audience list or removes the user from the audience list, the user added or removed based on the user request 102.

The audience measurement data controller 316 can receive media identifying information from the evaluator 312 and/or audience identification data from the people identifier 314. In some examples, the audience measurement data controller 316 stores the information received from the evaluator 312 and/or the people identifier 314 in the data storage 318. In some examples, the audience measurement data controller 316 can periodically and/or a-periodically transmit, via the network communicator 340, the audience measurement information stored in the data storage 318. For example, the audience measurement data controller 316 can transmit the collected data to a central facility for aggregation and/or preparation of media monitoring reports.

The data storage 318 stores any data associated with the audio receiver 310, the evaluator 312, and/or the people identifier 314. For example, the data storage 318 can store information related to the fingerprint and/or watermark patterns received from the speech recognition system 104. The data storage 318 can be a cloud-based storage (e.g., storage on the network 112). In some examples, the data storage 318 may be implemented by any storage device and/or storage disc for storing data such as, for example, flash memory, magnetic media, optical media, etc. Furthermore, the data stored in the data storage 318 may be in any data format such as, for example, binary data, comma delimited data, tab delimited data, structured query language (SQL) structures, etc. While in the illustrated example the data storage 318 is illustrated as a single database, the data storage 318 can be implemented by any number and/or type(s) of databases.

The configuration memory 320 can be used to store an audio sensor configuration identifying which of the audio sensor(s) 302, 304, 306, 308 can be used to form an audio signal to be processed by the audio receiver 310. However, any other configurational and/or operational information can be additionally or alternatively stored. In some examples, panelist identification and/or audio signals used to recognize the presence of a panelist and/or a guest (e.g., non-panelist) in the media presentation environment can be stored in the configuration memory 320. In some examples, the configuration memory 320 can be updated using the configuration interface 322. The configuration memory 320 can be implemented by any device for storing data (e.g., flash memory, magnetic media, optical media, etc.). Data stored in the configuration memory 320 can be in any data format (e.g., binary data, comma delimited data, tab delimitated data, etc.).

The configuration interface 322 can receive configuration inputs from a user and/or an installer of the AME meter 108. In some examples, the configuration interface 322 allows the user and/or installer to indicate audio sensor configuration to be stored in the configuration memory 320. In some examples, the configuration interface 322 allows the user and/or installer to control operational parameters of the meter 108 (e.g., Internet-based credentials to be used by the network communication 340, setting of a household and/or panelist identifier, etc.). The configuration interface 322 can be implemented using a Bluetooth Low Energy radio, an infrared input, a universal serial (USB) connection, a serial connection, an Ethernet connection, etc. In some examples, the configuration interface 322 can be used to communicatively couple the AME meter 108 to a media device (e.g., the media presentation device) being used in the media presentation environment.

The power receiver 330 can be used to connect the AME meter 108 to a power source. For example, the power receiver 330 can be implemented as a universal serial bus (USB) receptacle to enable the AME meter 108 to be connected to a power source via a cable (e.g., a USB cable). In some examples, a media presentation device (e.g., used in the media presentation environment being monitored by the AME meter 108) includes a port (e.g., a USB port, a High Definition Media Interface (HDMI) port, an Ethernet port, etc.) that provides electrical power to an external device such as the AME meter 108. The power receiver 330 can be implemented in any fashion to facilitate receipt of electrical power from a media presentation device and/or any other power source (e.g., a wall outlet, etc.). In some examples, the battery 332 can be used to store power for use by the AME meter 108 to enable the operation of the AME meter 108 when power is not being supplied via the power receiver 330. In some examples, the battery 332 can be a lithium-ion battery. However, any other type of battery may additionally or alternatively be used. In some examples, the battery 332 can be rechargeable, such that the battery 332 can recharge while the power receiver 330 provides power to the AME meter 108.

The network communicator 340 can transmit audience measurement information provided by the audience measurement data controller 316 (e.g., data stored in the data storage 318) to a central facility of the audience measurement entity. In some examples, the network communicator 340 can be implemented using a WiFi antenna that communicated with a WiFi network hosted by a gateway. However, the network communicator 340 may additionally or alternatively be implemented by an Ethernet port that communicates via an Ethernet network (e.g., a local area network (LAN)). In some examples, the network communicator 340 can be implemented by a cellular radio.

While an example manner of implementing the example speech recognition system 104 is illustrated in FIG. 2, one or more of the elements, processes, and/or devices illustrated in FIG. 2 may be combined, divided, rearranged, omitted, eliminated, and/or implemented in any other way. Further, the example microphone(s) 202, the example speaker(s) 204, the example detector 206, the example executor 208, the example audio generator 210, and/or, more generally, the example speech recognition system 104 of FIG. 2 may be implemented by hardware, software, firmware and/or any combination of hardware, software and/or firmware. Thus, for example, either of the example microphone(s) 202, the example speaker(s) 204, the example detector 206, example executor 208, and/or example audio generator 210 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example microphone(s) 202, the example speaker(s) 204, the example detector 206, example executor 208, and/or example audio generator 210 is/are hereby expressly defined to include a tangible computer-readable storage device or storage disk, such as a memory storage device, a digital versatile disk (DVD), a compact disk (CD), a Blu-ray disk, etc. storing the software and/or firmware. Further still, the example microphone(s) 202, the example speaker(s) 204, the example detector 206, example executor 208, and/or example audio generator 210 of FIG. 2 may include one or more elements, processes, and/or devices in addition to, or instead of, those illustrated/described in connection with FIG. 2, and/or may include more than one of any or all of the illustrated/described elements, processes, and devices.

While an example manner of implementing the example AME meter 108 is illustrated in FIG. 3, one or more of the elements, processes, and/or devices illustrated in FIG. 3 may be combined, divided, rearranged, omitted, eliminated, and/or implemented in any other way. Further, the example audio sensor(s) 302, 304, 306, 308, the example audio receiver 310, the example evaluator 312, the example people identifier 314, the example audience measurement data controller 316, the example power receiver 330, the example network communicator 340, and/or, more generally, the example AME meter 108 of FIG. 3 may be implemented by hardware, software, firmware and/or any combination of hardware, software and/or firmware. Thus, for example, either of the example audio sensor(s) 302, 304, 306, 308, the example audio receiver 310, the example evaluator 312, the example people identifier 314, the example audience measurement data controller 316, the example power receiver 330, and/or the example network communicator 340 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example audio sensor(s) 302, 304, 306, 308, the example audio receiver 310, example evaluator 312, the example people identifier 314, the example audience measurement data controller 316, the example power receiver 330, and/or the example network communicator 340 is/are hereby expressly defined to include a tangible computer-readable storage device or storage disk, such as a memory storage device, a digital versatile disk (DVD), a compact disk (CD), a Blu-ray disk, etc. storing the software and/or firmware. Further still, the example audio sensor(s) 302, 304, 306, 308, the example audio receiver 310, example evaluator 312, the example people identifier 314, the example audience measurement data controller 316, the example power receiver 330, and/or the example network communicator 340 of FIG. 3 may include one or more elements, processes, and/or devices in addition to, or instead of, those illustrated/described in connection with FIG. 3, and/or may include more than one of any or all of the illustrated/described elements, processes, and devices.

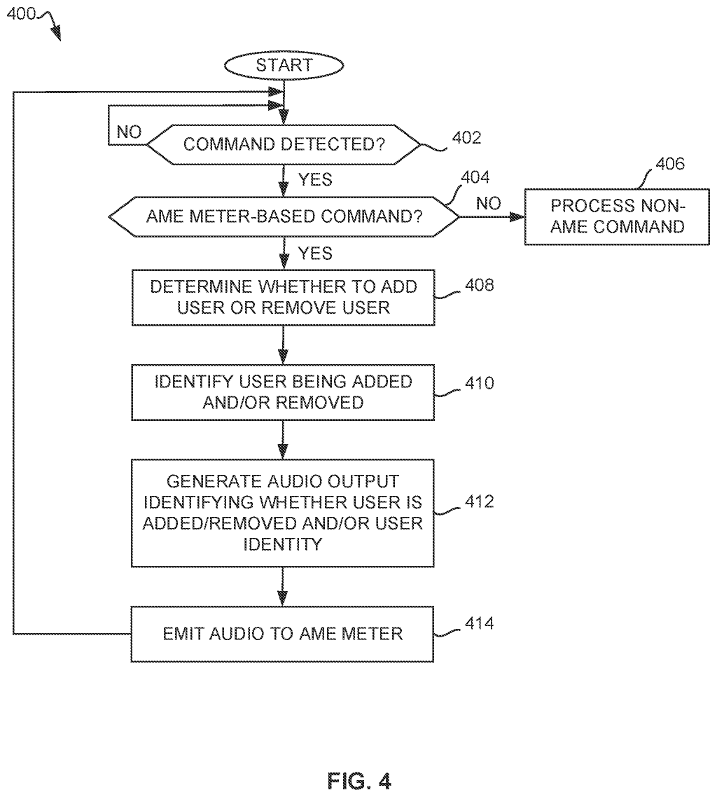

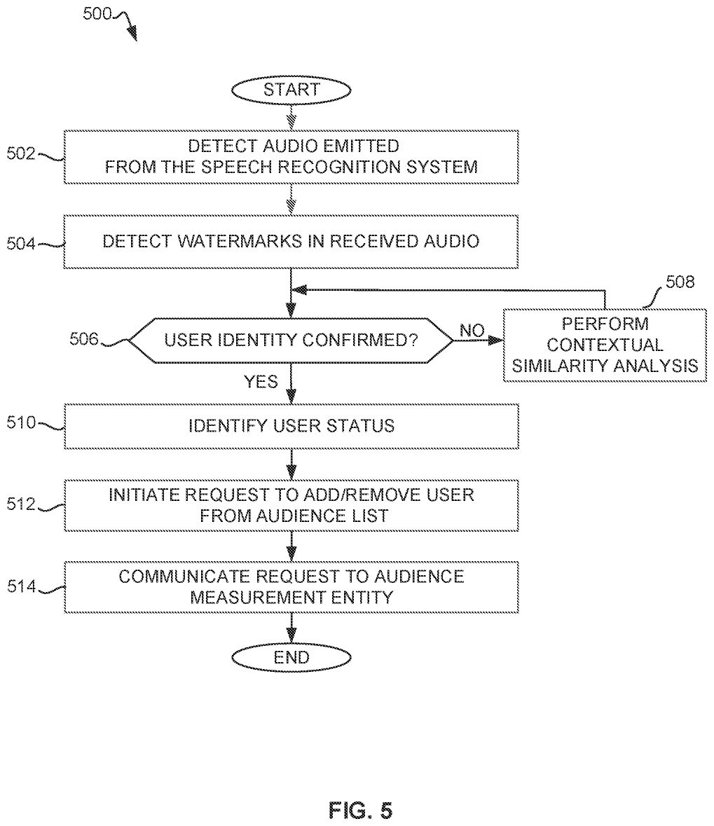

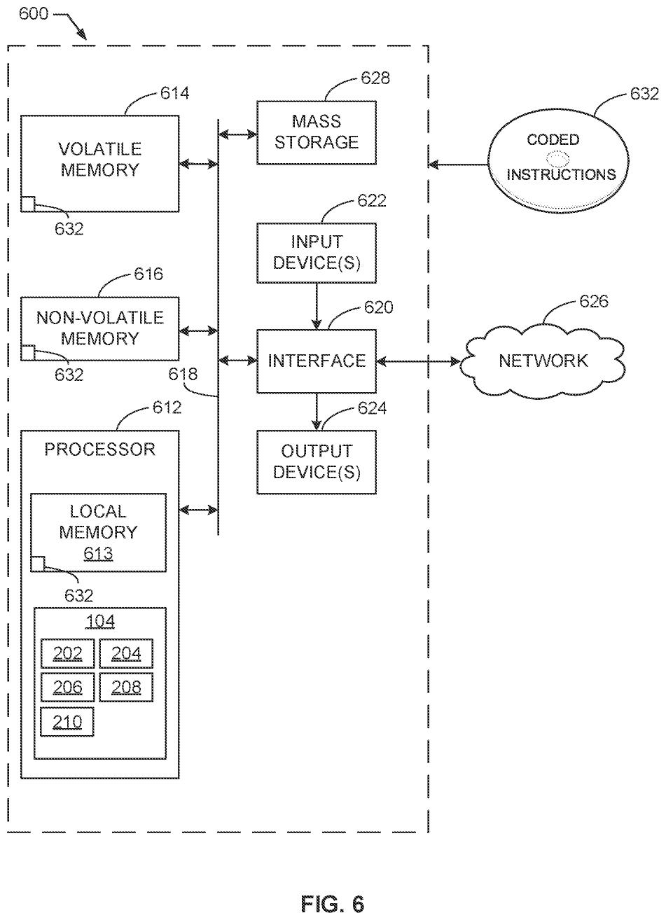

A flowchart representative of example machine readable instructions for implementing the example speech recognition system 104 of FIGS. 1 and/or 2 is shown in FIG. 4. A flowchart representative of example machine readable instructions for implementing the example AME meter 108 of FIGS. 1 and/or 3 is shown in FIG. 5. The machine-readable instructions may be one or more executable programs or portion(s) of an executable program for execution by a processor such as the processor(s) 612, 712 shown in the example processor platform(s) 600, 700 discussed below in connection with FIGS. 6 and/or 7. The program may be embodied in software stored on a non-transitory computer readable storage medium such as a CD-ROM, a floppy disk, a hard drive, a digital versatile disk (DVD), a Blu-ray disk, or a memory associated with the processor(s) 612, 712, but the entire program and/or parts thereof could alternatively be executed by a device other than the processor(s) 612, 712 and/or embodied in firmware or dedicated hardware. Further, although the example program is described with reference to the flowcharts illustrated in FIGS. 4 and/or 5, many other methods of implementing the speech recognition system 104 and/or the AME meter 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3 and/or 4 may be implemented using executable instructions (e.g., computer and/or machine readable instructions) stored on a non-transitory computer and/or machine readable medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 4 is a flowchart representative of machine readable instructions 400 which may be executed to implement elements of the example speech recognition system 104 of FIGS. 1 and/or 2. In the example of FIG. 4, the detector 206 detects a user-based command (e.g., the user request 102 of FIG. 1) (block 402) using microphone(s) 202. In some examples, the detector 206 identifies a wake word used to indicate to the speech recognition system 104 that the user (e.g., a panelist) is speaking. In some examples, the detector 206 identifies the user request 102 based on other keyword spotting and/or based on the recognition of the panelist's voice. In some examples, the user request 102 can be any request initiated by the panelist and/or any member of the household (e.g., a log-in request, a log-out request, a request for assistance, a request to add another member of the household to the audience list, etc.). In some examples, the speech recognition system 104 can use the speaker(s) 204 to confirm the user request 102. If the detector 206 identifies the user request 102 as an AME meter-based command (e.g., log in a panelist, log in a guest, etc.) (block 404), control can pass to the executor 208 to determine whether to add or remove the user (block 408). In some examples, the user request 102 may be related to another request not specific to the AME meter 108. If the detector 206 identifies the user request 102 as not relevant to the AME meter 108 (e.g., a request for a weather forecast, etc.), the speech recognition system 104 can process the non-AME command separately (block 406). Once the detector 206 detects the user request 102 as an AME meter-based request (block 404), the executor 208 processes the request to determine the content and/or category of the user request 102 (e.g., log-in request, request for assistance, etc.). For example, the executor 208 determines whether to add the user or remove the user from the audience list based on the detected user request (block 408). For example, based on the content of the user request (e.g., add the user or remove the user), the executor 208 determines whether to transmit audio to the AME meter 108 indicating that the user should be added or removed from an audience list. In some examples, the executor 208 determines whether to include a watermark to the AME meter 108 with or without any acoustic masking using the audio generator 210. The executor 208 can incorporate a user identifier into the audio generated by the speech recognition system 104 to allow the AME meter 108 to determine which user is being referred to in the emitted audio output (e.g., external audio detected by the AME meter 108 audio sensors) Furthermore, the executor 208 can identify the user being added/removed from the audience list based on the received user command (e.g., using voice recognition and/or the user's specified request) (block 410). The audio generator 210 generates the audio output (e.g., including a watermark and/or fingerprint) identifying the user and/or the user status (e.g., to be removed from the audience list, to be added to the audience list, etc.) (block 412). The speech recognition system 104 emits the generated audio to the AME meter 108 for further processing (block 414). In some examples, the speech recognition system 104 continues to monitor for additional user request(s) 102 (block 402). If another user request 102 is detected, the audio generator 210 outputs another user-specific audio associated with the request (block 412), which can then be processed by the AME meter 108, as described in connection with FIG. 5.

FIG. 5 is a flowchart representative of machine readable instructions 500 which may be executed to implement elements of the example AME meter 108 of FIGS. 1 and/or 3. In the example of FIG. 5, the audio sensor(s) 302, 304, 306, 308 detect external audio generated by the speech recognition system 104 (block 502). For example, the audio receiver 310 receives the audio (e.g., as generated by the audio generator 210). The audio receiver 310 detects watermark(s) and/or fingerprints in the broadcast received from the speech recognition system 104 (block 504). In some examples, the evaluator 312 identifies the user based on the watermark and/or fingerprint included in the broadcast received from the speech recognition system 104 (block 506). For example, the evaluator 312 can determine whether the watermark and/or fingerprint correspond to a specific watermark and/or fingerprint in the AME meter 108 database (e.g., data storage 318). The evaluator 312 can further process the user identifier incorporated into the audio by the speech recognition system 104. If the evaluator 312 identifies a match between the received watermark and/or fingerprint and the existing watermark and/or fingerprint programmed into the AME meter 108, the evaluator 312 can determine information including, but not limited to, the panelist identity and/or the panelist request (e.g., log-in request, log-out request, etc.). In some examples, the user identity can be confirmed using the evaluator 312 based on existing panelist identifiers configured using the configuration interface 322 of FIG. 3. If user identity is confirmed, the people identifier 314 can match the user to the user's status (e.g., logging in, logging out, etc.) (block 510). However, if user identity is not confirmed, the evaluator 312 and/or the people identifier 314 can perform an assessment of the received audio to identify errors (block 508). For example, the evaluator 312 can perform a semantic and/or contextual similarity analysis to determine whether a user's identity is unidentifiable due to the use of a nickname (e.g., “Bob” in place of “Robert”, etc.) in the user's request. The evaluation of the audio can be performed until the user identity is confirmed (block 506). Otherwise, the user identity can be tagged as corresponding to a guest of the registered panelist(s) for a given household. Once the user's identity has been identified, the user is matched to a log-in request or a log-out request using the people identifier 314. As such, the AME meter 108 determines whether to initiate a request to add the user to the audience or remove the user from the existing audience list (block 512). Once the people identifier 314 has associated the user and/or a guest of the user with a log-in request or a log-out request, the AME meter 108 communicates the user identity and status to the audience measurement entity via the network communicator 340 (block 514).

FIG. 6 is a block diagram of an example processing platform 600 structured to execute the instructions of FIG. 4 to implement the example speech recognition system 104 of FIGS. 1 and/or 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 600 of the illustrated example includes a processor 612. The processor 612 of the illustrated example is hardware. For example, the processor 612 can be implemented by one or more integrated circuits, logic circuits, microprocessors, GPUs, DSPs, or controllers from any desired family or manufacturer. The hardware processor 612 may be a semiconductor based (e.g., silicon based) device. In this example, the processor 612 implements the example microphone(s) 202, the example speaker(s) 204, the example detector 206, the example executor 208, and/or the example audio generator 210 of FIG. 2.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), a Bluetooth® interface, a near field communication (NFC) interface, and/or a PCI express interface.

In the illustrated example, one or more input devices 622 are connected to the interface circuit 620. The input device(s) 622 permit(s) a user to enter data and/or commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 620 of the illustrated example, thus, typically includes a graphics driver card, a graphics driver chip and/or a graphics driver processor.

The interface circuit 620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 626. The communication can be via, for example, an Ethernet connection, a digital subscriber line (DSL) connection, a telephone line connection, a coaxial cable system, a satellite system, a line-of-site wireless system, a cellular telephone system, etc.

The processor platform 600 of the illustrated example also includes one or more mass storage devices 628 for storing software and/or data. Examples of such mass storage devices 628 include floppy disk drives, hard drive disks, compact disk drives, Blu-ray disk drives, redundant array of independent disks (RAID) systems, and digital versatile disk (DVD) drives. Machine executable instructions 632 represented in FIG. 4 may be stored in the mass storage device 628, in the volatile memory 614, in the non-volatile memory 616, and/or on a removable non-transitory computer readable storage medium such as a CD or DVD.

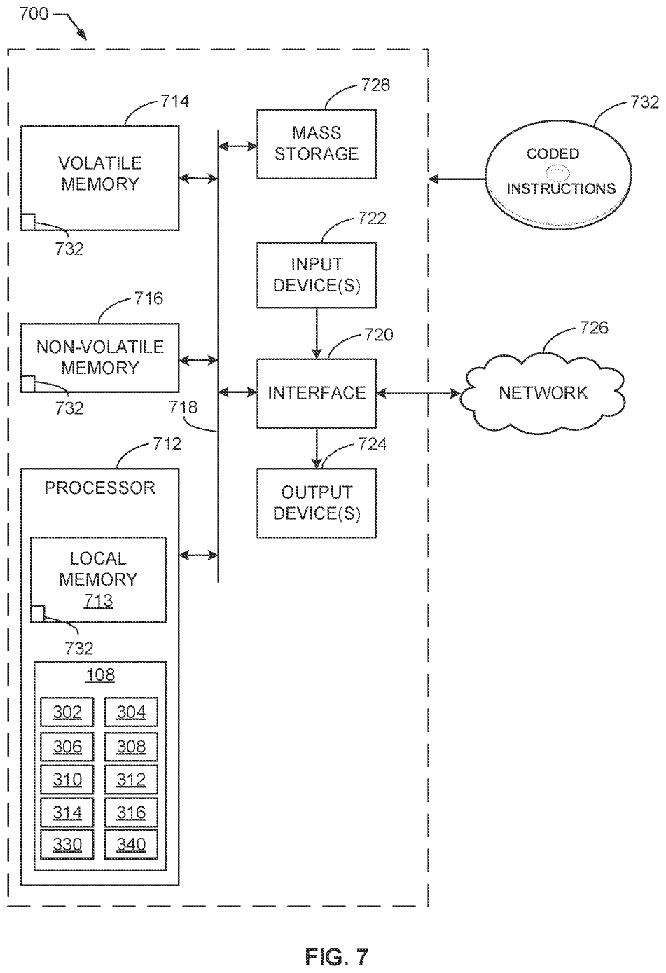

FIG. 7 is a block diagram of an example processing platform 700 structured to execute the instructions of FIG. 5 to implement the example AME meter 108 of FIGS. 1 and/or 3. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor 712 may be a semiconductor based (e.g., silicon based) device. In this example, the processor 712 implements the example audio sensor(s) 302, 304, 306, 308, the example audio receiver 310, the example evaluator 312, the example people identifier 314, the example audience measurement data controller 316, the example power receiver 330, and/or the example network communicator 340 of FIG. 3.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives. Machine executable instructions 732 represented in FIG. 4 may be stored in the mass storage device 728, in the volatile memory 714, in the non-volatile memory 716, and/or on a removable non-transitory computer readable storage medium such as a CD or DVD.

From the foregoing, it will be appreciated that the above disclosed methods, apparatus, and articles of manufacture permit panelist-based logins using voice commands. For example, an AME meter can be used to receive user-based requests initiated via a speech recognition system (e.g., Amazon Alexa, Google Home, Apple Homepod, etc.). For example, the AME meter(s) can extract audio fingerprints and/or audio watermarks used for content recognition while delegating speech recognition to a smart device (e.g., the speech recognition system) present in a panelist home, thereby reducing the computational resources needed to process the user request information. In the example disclosed herein, the smart device can be programmed to respond to login requests by playing a sound which can be detected by the AME meter(s). As such, the AME meter can receive a sound burst (e.g., audio signal) from the speech recognition system given that the AME meter is searching for watermarks and/or fingerprints in real-time.

Example methods and apparatus for panelist-based logins using voice commands are disclosed herein. Further examples and combinations thereof include the following:

Example 1 includes an apparatus for identifying a user as a member of an audience, comprising memory, and at least one processor to execute machine readable instructions to at least access audio emitted by a speech recognition system, the audio generated based on a request spoken by the user, identify at least one of a watermark or a fingerprint included in the audio, the watermark or fingerprint including identifying information to identify a user and an indication of a presence of the user, and record the indication of the presence of the user in an audience.

Example 2 includes the apparatus of example 1, wherein the audio emitted by the speech recognition system is accessed using an audience measurement entity-based meter.

Example 3 includes the apparatus of example 1, wherein the speech recognition system is a virtual assistant.

Example 4 includes the apparatus of example 1, further including an audio sensor to receive the audio emitted by the speech recognition system.

Example 5 includes the apparatus of example 1, wherein the user request is either a log-in request or a log-out request.

Example 6 includes the apparatus of example 1, wherein the user is a panelist of an audience measurement entity.

Example 7 includes the apparatus of example 1, wherein the user request includes an update of a number of guests in the audience.

Example 8 includes the apparatus of example 1, wherein the audio includes a user identifier of the user, the user identifier encoded into the audio by the speech recognition system.

Example 9 includes a method for identifying a user as a member of an audience, including accessing audio emitted by a speech recognition system, the audio generated based on a request spoken by the user, identifying at least one of a watermark or a fingerprint included in the audio, the watermark or fingerprint including identifying information to identify a user and an indication of a presence of the user, and recording the indication of the presence of the user in an audience.

Example 10 includes the method of example 9, wherein the accessing, identifying, and recording is performed by an audience measurement entity-based meter.

Example 11 includes the method of example 9, wherein the speech recognition system is a virtual assistant.

Example 12 includes the method of example 9, further including an audio sensor to receive the audio emitted by the speech recognition system.

Example 13 includes the method of example 9, wherein the user request is either a log-in request or a log-out request.

Example 14 includes the method of example 9, wherein the user is a panelist of an audience measurement entity.

Example 15 includes the method of example 9, further including updating a number of guests in the audience.

Example 16 includes the method of example 9, further including identifying a user identifier of the user, the user identifier encoded into the audio by the speech recognition system.

Example 17 includes a non-transitory computer readable storage medium comprising instructions that, when executed, cause a processor to at least access audio emitted by a speech recognition system, the audio generated based on a request spoken by a user, identify at least one of a watermark or a fingerprint included in the audio, the watermark or fingerprint including identifying information to identify a user and an indication of a presence of the user, and record the indication of the presence of the user in an audience.

Example 18 includes the non-transitory computer readable storage medium of example 17, wherein the speech recognition system is a virtual assistant.

Example 19 includes the non-transitory computer readable storage medium of example 17, wherein the instructions, when executed, cause the processor to receive the audio emitted by the speech recognition system using an audio sensor.

Example 20 includes the non-transitory computer readable storage medium of example 17, wherein the user request is either a log-in request or a log-out request.

Example 21 includes the non-transitory computer readable storage medium of example 17, wherein the user is a panelist of an audience measurement entity.

Example 22 includes the non-transitory computer readable storage medium of example 17, wherein the instructions, when executed, cause the processor to update a number of guests in the audience.

Example 23 includes the non-transitory computer readable storage medium of example 17, wherein the instructions, when executed, cause the processor to identify a user identifier of the user, the user identifier encoded into the audio by the speech recognition system.

Example 24 includes an apparatus for identifying a user as a member of an audience, comprising an audio receiver to access audio emitted by a speech recognition system, the audio generated based on a request spoken by the user, an evaluator to identify at least one of a watermark or a fingerprint included in the audio, the watermark or fingerprint including identifying information to identify a user and an indication of a presence of the user, and a people identifier to record the indication of the presence of the user in an audience.

Example 25 includes the apparatus of example 24, wherein the audio receiver is an audience measurement entity-based meter.

Example 26 includes the apparatus of example 24, wherein the speech recognition system is a virtual assistant.

Example 27 includes the apparatus of example 24, further including an audio sensor to receive the audio emitted by the speech recognition system.

Example 28 includes the apparatus of example 24, wherein the user request is either a log-in request or a log-out request.

Example 29 includes the apparatus of example 24, wherein the user is a panelist of an audience measurement entity.

Example 30 includes the apparatus of example 24, wherein the user request includes an update of a number of guests in the audience.

Example 31 includes the apparatus of example 24, wherein the evaluator identifies a user identifier of the user, the user identifier encoded into the audio by the speech recognition system.

Example 32 includes an apparatus for identifying a user as a member of an audience, comprising means for accessing audio emitted by a speech recognition system, the audio generated based on a request spoken by the user, means for identifying at least one of a watermark or a fingerprint included in the audio, the watermark or fingerprint including identifying information to identify a user and an indication of a presence of the user, and means for recording the indication of the presence of the user in an audience.

Example 33 includes the apparatus of example 32, wherein the audio is accessed using an audience measurement entity-based meter.

Example 34 includes the apparatus of example 32, wherein the speech recognition system is a virtual assistant.

Example 35 includes the apparatus of example 32, further means for detecting the audio emitted by the speech recognition system.

Example 36 includes the apparatus of example 32, wherein the user request is either a log-in request or a log-out request.

Example 37 includes the apparatus of example 32, wherein the user is a panelist of an audience measurement entity.

Example 38 includes the apparatus of example 32, wherein the user request includes an update of a number of guests in the audience.

Example 39 includes the apparatus of example 32, wherein the means for identifying include identifying a user identifier of the user, the user identifier encoded into the audio by the speech recognition system.

Although certain example methods, apparatus, and articles of manufacture have been disclosed herein, the scope of coverage of this patent is not limited thereto. On the contrary, this patent covers all methods, apparatus and articles of manufacture fairly falling within the scope of the claims of this patent.

1. An apparatus for identifying a user as a member of an audience, comprising:
memory; and
at least one processor to execute machine readable instructions to at least:
access audio emitted by a speech recognition system, the audio generated based on a request spoken by the user;
identify at least one of a watermark or a fingerprint included in the audio, the watermark or fingerprint including identifying information to identify a user and an indication of a presence of the user;
confirm an identity of the user based on a contextual similarity analysis; and
record the indication of the presence of the user in an audience.

2. The apparatus of claim 1, wherein the audio emitted by the speech recognition system is accessed using an audience measurement entity-based meter.

3. The apparatus of claim 1, wherein the speech recognition system is a virtual assistant.

4. The apparatus of claim 1, further including an audio sensor to receive the audio emitted by the speech recognition system.

5. The apparatus of claim 1, wherein the user request is either a log-in request or a log-out request.

6. The apparatus of claim 1, wherein the user is a panelist of an audience measurement entity.

7. The apparatus of claim 1, wherein the user request includes an update of a number of guests in the audience.

8. The apparatus of claim 1, wherein the audio includes a user identifier of the user, the user identifier encoded into the audio by the speech recognition system.

9. A method for identifying a user as a member of an audience, including:
accessing audio emitted by a speech recognition system, the audio generated based on a request spoken by the user;
identifying at least one of a watermark or a fingerprint included in the audio, the watermark or fingerprint including identifying information to identify a user and an indication of a presence of the user;
confirming an identity of the user based on a contextual similarity analysis; and
recording the indication of the presence of the user in an audience.

10. The method of claim 9, wherein the accessing, identifying, and recording is performed by an audience measurement entity-based meter.

11. The method of claim 9, wherein the speech recognition system is a virtual assistant.

12. The method of claim 9, further including an audio sensor to receive the audio emitted by the speech recognition system.

13. The method of claim 9, wherein the user request is either a log-in request or a log-out request.

14. The method of claim 9, wherein the user is a panelist of an audience measurement entity.

15. The method of claim 9, further including updating a number of guests in the audience.

16. The method of claim 9, further including identifying a user identifier of the user, the user identifier encoded into the audio by the speech recognition system.

17. A non-transitory computer readable storage medium comprising instructions that, when executed, cause a processor to at least:
access audio emitted by a speech recognition system, the audio generated based on a request spoken by a user;
identify at least one of a watermark or a fingerprint included in the audio, the watermark or fingerprint including identifying information to identify a user and an indication of a presence of the user;
confirm an identity of the user based on a contextual similarity analysis; and
record the indication of the presence of the user in an audience.

18. The non-transitory computer readable storage medium of claim 17, wherein the speech recognition system is a virtual assistant.

19. The non-transitory computer readable storage medium of claim 17, wherein the instructions, when executed, cause the processor to receive the audio emitted by the speech recognition system using an audio sensor.

20. The non-transitory computer readable storage medium of claim 17, wherein the user request is either a log-in request or a log-out request.

21.-39. (canceled)
